(19) United States
(12) Patent Application Publication
(10) Pub. No.: US 2005/0011529 A1
(43) Pub. Date: Jan. 20, 2005

(54) Method and arrangement for processing finite fibers for use in the manufacture of filters

(75) Inventors: Sonke Horn, Geesthacht (DE); Thorsten Scherbarth, Geesthacht (DE); Peter-Franz Arnold, Hamburg (DE); Stephan Wolff, Glinde (DE); Alexander Buhl, Robertsdorf (DE)

Correspondence Address: VENABLE, BAETJER, HOWARD AND CIVILETTI, LLP, P.O. BOX 34385, WASHINGTON, DC, 20043-9998, US

(73) Assignee: Hauni Maschinenbau, Hamburg (DE)

(21) Appl. No.: 10/815,959

(22) Filed: Apr. 2, 2004

(30) Foreign Application Priority Data
Apr. 3, 2003 (EP) 03 007 672.3

(51) Int. Cl. B31C 13/00

(52) U.S. Cl. 131/331; 493/39

(57) ABSTRACT

The invention relates to a method for processing filter material for use in the manufacture of tobacco industry filters wherein a mass of finite fibers is feed to a separating device wherein finite fibers are separated into essentially individual separated fibers and then transported to a continuous rod machine.

### CROSS REFERENCE TO RELATED APPLICATIONS

This application claims the priority of European Patent Application Serial No. 03 007 672.3, filed on Apr. 3, 2003, the subject matter of which, together with each and every U.S. and foreign patent and patent application mentioned below, is incorporated herein by reference.

### BACKGROUND OF THE INVENTION

The invention relates to a method for processing finite fibers for use in the manufacture of filters in the tobacco industry. The invention furthermore relates to an arrangement for processing finite fibers for use in the manufacture of filters in the tobacco industry, comprising at least one device for separating the finite fibers and at least one metering device, wherein at least one means is provided for transporting the finite fibers from the at least one metering device to at least one separating device.

A method and corresponding arrangement for processing filter materials for the manufacture of filters in the tobacco industry are known from British patent document GB 718 332. According to this document, material cuttings are produced with a tobacco cutter and these are fed to a continuous rod machine, such as cigarette rod machines. The cuttings are impregnated with a chemical agent to prevent an undesirable taste and to prevent them from falling out of the end pieces of the respectively produced filters. The cuttings are conveyed with a roller to the range of operation for a spiked feed roller and are then moved with the spiked feed roller to a conveying belt, so that they can subsequently be fed to a different spiked feed roller. The cuttings are then knocked from this spiked feed roller by a different spiked or beater roller and supplied to a format device where the continuous filter rod is formed by wrapping a material web around the fiber rod. The cuttings consist of paper, cellulose, textile, synthetic materials and the like and have a texture that is similar to cut tobacco.

The shape of the cuttings makes it very difficult to produce filters with homogeneous characteristics. In addition, the options for adjusting the filter characteristics are very limited.

### BRIEF SUMMARY OF THE INVENTION

It is an object of the present invention to provide a method and an arrangement for processing filter material for use in the manufacture of filters in the tobacco industry, which make it possible to produce extremely homogeneous filters and which permit a high variability in the characteristics of the filters to be produced.

This object is solved with a method for processing filter material for use in the manufacture of filters in the tobacco industry, involving the following processing steps of feeding a mass of finite fibers to a separating device where the fibers are separated into essentially individual fibers and transporting the essentially individual fibers to a continuous rod-producing machine.

Extremely homogeneous filter characteristics can be obtained by using compiled, woven or nonwoven finite fiber material (“finite fibers”) as filter material and by essentially completely separating the fibers prior to forming a continuous rod from which the individual filters are subsequently formed. The essentially complete separation of the finite fibers, in particular, is extremely important since only separated fibers, which are subsequently reshaped into a nonwoven fiber composite, allow the forming of a nonwoven filter with an essentially uniform and homogeneous density.

The flow of separated finite fibers resembles the image of a snow storm, meaning it is a flow of fibers with a homogeneous static distribution of the fibers with respect to space and time. In particular, the complete separation of the fibers means that essentially there are no more connecting groups of fibers. A composite fiber material, for example with a nonwoven fiber structure, is created only after the fibers are separated. By breaking up the fiber groups and separating the fibers into individual fibers, a nonwoven fiber composite can be formed that does not contain bridge-type connections and cavities.

If the separated fibers are transported at least in part by means of an air flow, the separated fibers can be transported without forming fiber groups. For one particularly preferred embodiment of the method according to the invention, the fibers are separated at least in part with the aid of an air flow, thus resulting in an extremely high degree of separation. A large volume of air is used to help separate the fibers. Excess air is then removed at least partially from the fiber flow in the region of a fluidized bed.

A high degree of separation is possible if the fibers are separated at least in part while passing through the openings of a device provided with a plurality of openings. Pre-separated fibers remain essentially separated during the feeding operation if the fibers are supplied at least in part with an air flow. The separated fibers and also the fiber groups that are processed prior to the essentially complete separation of the fibers are primarily supplied only with transport air and/or an air flow.

A higher degree of fiber separation is achieved if at least two separation steps are used. Finite composite fibers are preferably pre-separated by using a hammer crusher or a bale breaker. A hammer crusher is used to break up a fiber felt while a bale breaker is used to break up a fiber bale.

At least one metering step is provided according to one preferred modification of the method according to the invention, by means of which the fiber amount, in particular, can be metered out. A pre-metering and/or a primary metering can be provided for this. A rough adjustment of the throughput rate of the fibers to be processed is possible with the pre-metering, whereas a more precise adjustment is possible with the primary metering.

A particularly efficient and quick process sequence is possible if at least one metering step occurs at the same time as a separation step.

Different types of fibers are preferably used, so that filters with different filtering characteristics can be produced. Cellulose acetate, cellulose, carbon fibers and multi-component fibers, especially bi-component fibers, for example, can be considered for the fiber materials. With respect to the components in question, reference is made in particular to German patent document DE 102 17 410.5 commonly owned by the assignee of this application. DE 102 17 410.5 corresponds to US 2003/0213496 A1.

The different fiber types are advantageously mixed together, wherein at least one additive can be mixed in. In particular, the additive can be a bonding agent such as latex or a granulated material that is particularly effective for binding cigarette-smoke components, e.g. activated carbon granulate.

According to one particularly preferred embodiment of the method according to the invention, a complete fiber separation takes place along with or following a second or third metering step, wherein the separation following a third metering step in particular is possible with a pre-metering. It is particularly preferable if the fiber length is shorter than the length of the filter to be produced. With respect to the filter length, reference is also made German patent document DE 102 17 410.5 commonly owned by the assignee of the present application, the content of which is incorporated herein by reference. It is preferred that the fiber length be between 0.1 mm and 30 mm and, in particular, between 0.2 mm and 10 mm. The filter to be produced has a standard cigarette-filter length and/or filter segment length in case of multi-segment cigarette filters. An extremely homogeneous filter based on the processing according to the invention can be produced if the average fiber diameter is additionally in the range of 10 to 40 μm, particularly 20 to 38 μm and especially preferred between 30 and 35 μm.

It is preferable if a method for producing filters, involving a process according to the invention for processing filter material as described herein, is provided which additionally is used for forming a continuous fiber rod and dividing the continuous fiber rod into individual filter rods, such as used in the tobacco industry. The fiber length transported to the continuous rod machine is preferably shorter than the length of the divided filter rod section or filter.

According to the method for producing filters in the tobacco industry, a nonwoven filter is preferably formed from the separated finite fibers no later than during the forming of the continuous rod. To form this continuous rod of finite fibers, the fibers are transported in a continuous flow to a suction belt conveyor, thus forming a nonwoven fiber composite on the surface of the suction belt conveyor. The suction belt conveyor is specifically designed to keep the finite fibers, e.g. with a relatively small diameter, on the suction belt. Essentially, the continuous rod is formed in the same way as a continuous tobacco rod. However, respective measures and variations are introduced for turning the finite fiber material, which differs in size and structure as compared to tobacco fibers, into a homogeneous continuous rod. Reference is made here in particular to European Patent Application No: EP 03 007 675.6, filed on Apr. 3, 2003 and entitled “VERFAHREN UND EINRICHTUNG ZUR HERSTELLUNG EINES FILTERSTRANGS” [Method and Machine for Producing a Continuous Filter Rod], and commonly owned by the assignee of the present application.

The object is furthermore solved with an arrangement for processing filter material for use in the manufacture of filters in the tobacco industry, the arrangement comprising at least one device for separating the filter material and at least one metering device. At least one means for feeding the filter material from the at least one metering device to the at least one separating device is provided, wherein the processing arrangement is adapted for processing filter material with finite fibers and wherein the at least one device for separating the finite fibers permits an essentially complete separation.

A filter with extremely homogeneous characteristics can be realized with the arrangement according to the invention and the correspondingly processed filter material.

The feeding means preferably comprises an air flow, which makes it possible to produce an even more homogeneous filter.

One particularly preferred embodiment of the arrangement according to the invention for processing fibers requires an air flow through and/or in the arrangement for separating the fibers, which results in an extremely high degree of separation. The separating device of a particularly effective processing arrangement is provided with a plurality of openings through which the separated fibers can individually exit the arrangement.

A particularly easy to realize metering device comprises a drop chute from which a rotating roller removes the fibers. A pair of feed rollers can be used in the lower region of the metering device for metering the filter material in a careful manner.

A particularly good and homogeneous separation occurs if the separating device separates the fibers through a joint operation of at least one rotating element, and at least one element provided with passages and an air flow. The at least one metering device preferably also has a separating function, which can further increase the degree of separation of the complete processing arrangement. Different materials and also different fibers can be processed if a mixing device is provided, wherein the fibers can be cellulose fibers, fibers of a thermoplastic strength, flax fibers, hemp fibers, linseed fibers, sheep's wool fibers and cotton fibers or can be multi-component fibers, as previously described above. The mixing device preferably permits an additional separation and/or metering of the fibers, thus making possible an extremely compact design for the arrangement.

The arrangement for one particularly preferred embodiment of the invention is designed such that finite fibers with a length shorter than that of the filter to be produced can be processed. The arrangement is furthermore designed for processing finite fibers with an average fiber diameter in the range of 10 to 40 μm, in particular 20 to 38 μm and especially preferred in the range of 30 to 35 μm.

According to another as part of the invention, a filter production machine is provided comprising a processing arrangement as herein described.

A filter according to the invention is produced with one of the herein described methods.

### BRIEF DESCRIPTION DRAWINGS

The invention is described in the following by referring to the drawings, to which we otherwise refer with respect to all details not mentioned specifically in the text. Shown are in:

FIG. 1 is a schematic block diagram of the several sequences for processing filter material;

FIG. 2 is a schematic cross-sectional side view representation of one arrangement for the separation of filter material from a mass of filter material;

FIG. 3 is a schematic cross-sectional side view representation of one embodiment of a pre-metering device for the controlled metering of material;

FIG. 4 is a schematic cross-sectional side view representation of one embodiment of a primary metering device for the controlled metering of material;

FIG. 5 is a three-dimensional schematic representation of a mixing device for the mixing of different filter materials;

FIG. 6 is a schematic cross-sectional side view representation of one arrangement of a metering device containing a filter material separating device;

FIG. 7 is a schematic cross-sectional side view representation of one arrangement of a primary metering device containing another embodiment of a filter material separating device;

FIG. 8 is a schematic cross-sectional side view representation of one arrangement of a primary metering device containing another embodiment of a filter material separating device;

FIG. 9 is a three-dimensional schematic representation of another embodiment of a filter material separating device;

FIG. 10 is a side perspective view of one arrangement of a continuous filter rod making apparatus;

FIG. 11 is a top down perspective view of the continuous filter rod making machine apparatus of FIG. 10 as viewed from the ‘A’ location;

FIG. 12 is a end on schematic perspective view of the continuous filter rod making machine apparatus of FIG. 10 as viewed from the ‘B’ location;

FIG. 13 is a schematic three-dimensional view of yet another embodiment of a filter material separating device;

FIG. 14 is a schematic cross-sectional side view of a different embodiment of a filter material separating device separating device;

FIG. 15 is a schematic representation of the separating device of FIG. 14, additionally showing a granulate feed station; and

FIG. 16 is a schematic representation of the separating device of FIG. 15, showing the granulate feed station at an alternate location.

### DETAILED DESCRIPTION OF THE INVENTION

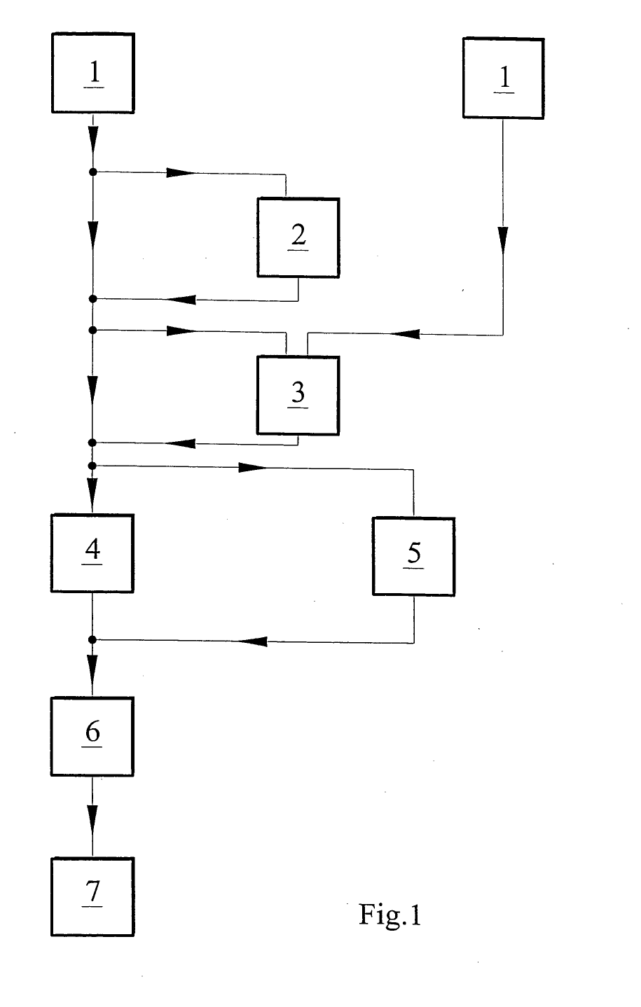

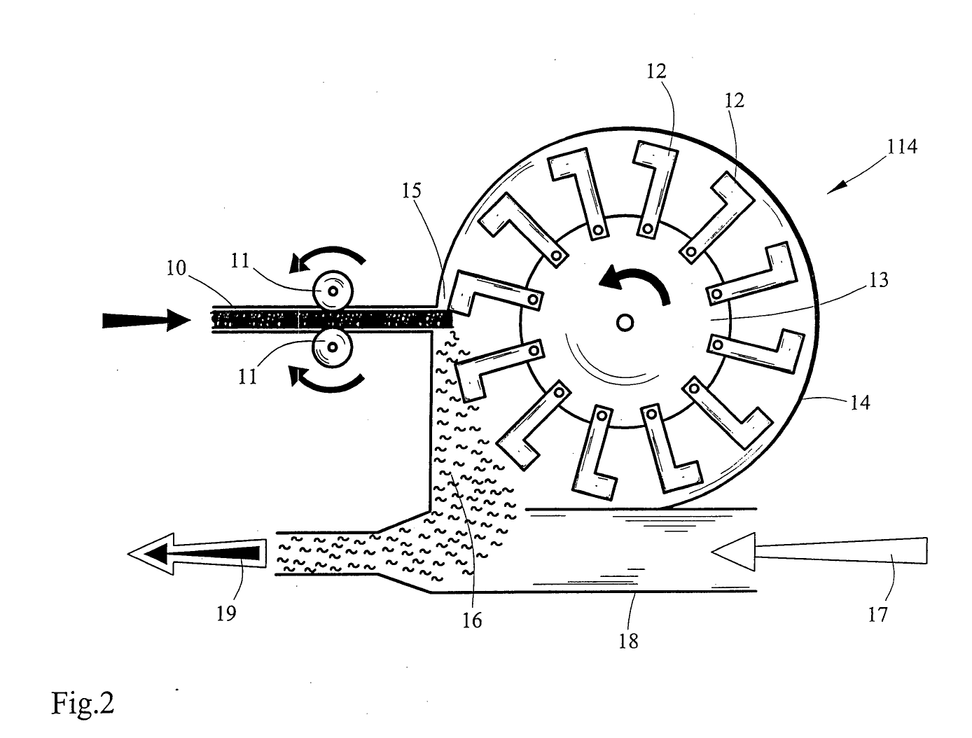

FIG. 1 is a block diagram of the method steps, ranging from a fiber processing to a continuous rod production, for producing a filter for use in the tobacco industry. A variable process sequence is possible owing to the different types of process sequences that can be used. The example in FIG. 1 shows initially a fiber preparation step 1, during which above all the fiber materials that are delivered in a solidly compressed form are changed to an airy-cottony state. Individual fibers can also be generated in addition to these fiber groups. The fiber preparation 1 is realized, for example, with an arrangement as shown in FIG. 2, which is known per se. The forms that solidly compressed fiber 10 may be delivered include, for example, fiber bales and fiber mats as well as fiber felt. Fiber bales are normally opened with a bale breaker and fiber mats and/or fiber felt are opened with a hammer crusher.

Non-compressed fiber materials that are densely packaged are also loosened up during the fiber preparation stage and puffed up to form an airy, cottony state. A bale breaker for fiber materials can be purchased, for example, from the company Trützschler GmbH, Germany and a hammer crusher for fiber materials can be purchased from the company Kamas.

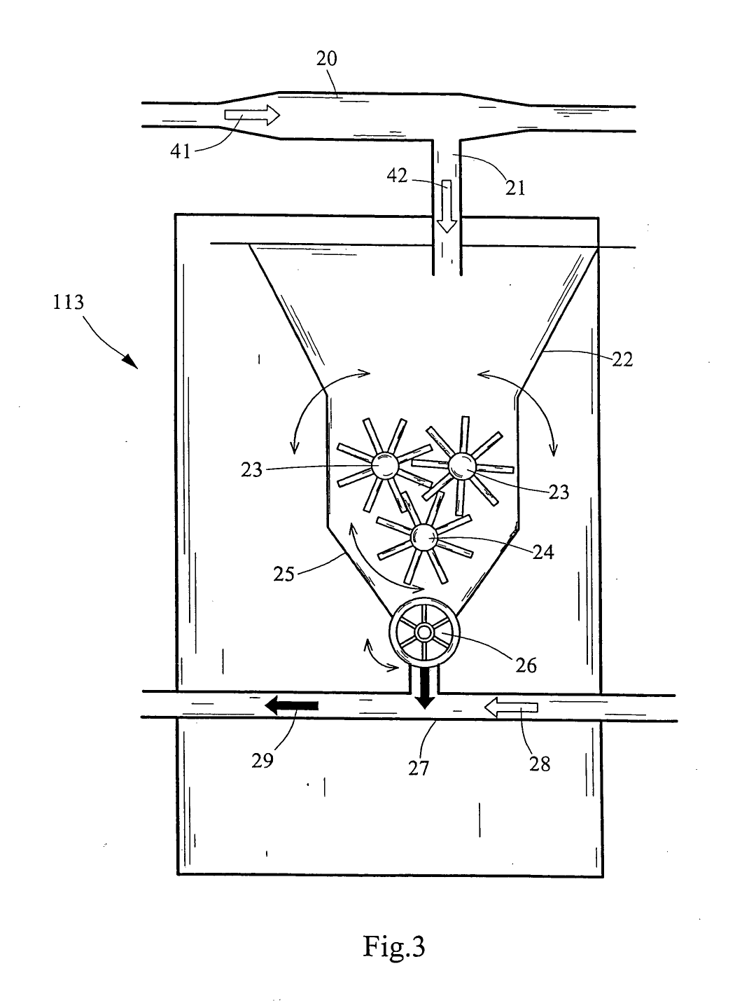

A pre-metering step 2, which can optionally be used with this exemplary embodiment, can represent a second step. The arrangement according to FIG. 3 permits a pre-metering step 2, wherein the pre-metering functions to roughly batch the fiber material and further separate it, such that the groups and/or the densely packed fibers are further loosened up, wherein additional separated fibers can develop at this point as well. In place of the pre-metering step 2, it is also possible to realize a primary metering and/or metering step 4 by itself. The condition of the material received from the fiber preparation 1 determines whether a pre-metering 2 step is required. The goal of the metering 4 and/or the pre-metering 2 is to realize a defined, stable and uniform mass flow of fibers and additionally, in part, also a pre-separation. The metering step 4 leads to a further separation of the fiber groups. Prior to the metering step 4, a mixing and/or metering step 3 can also be provided. During this step 3, several filter materials, as indicated in FIG. 1 with the paths from two or more fiber processors 1 leading to the box 3, and if necessary an additive, such as a bonding agent or activated carbon granulate, can also be mixed in.

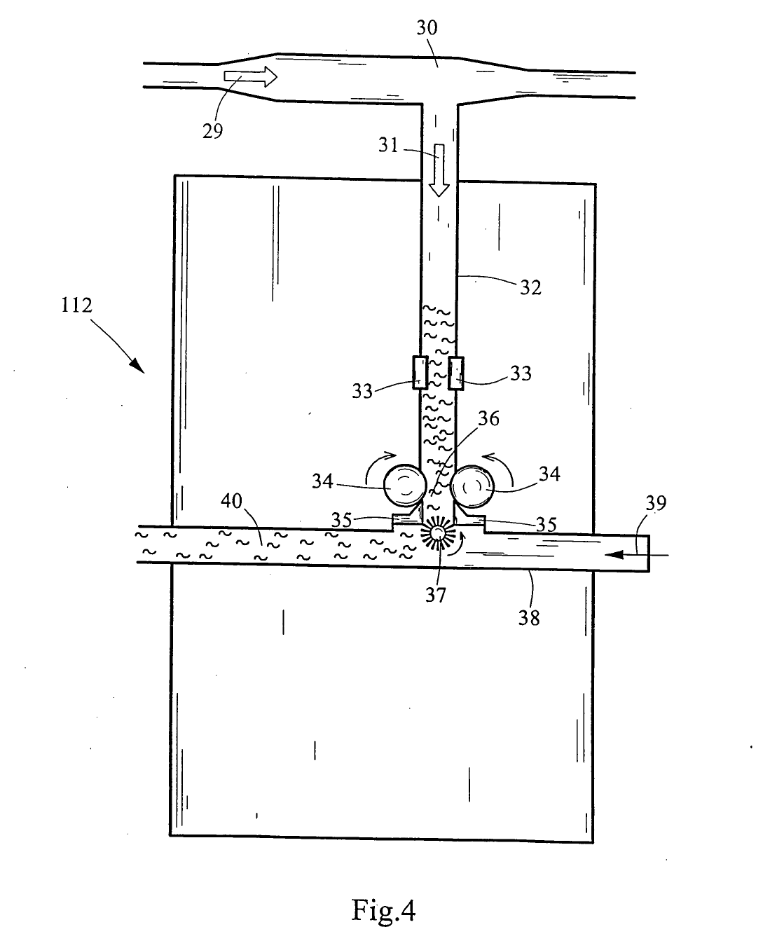

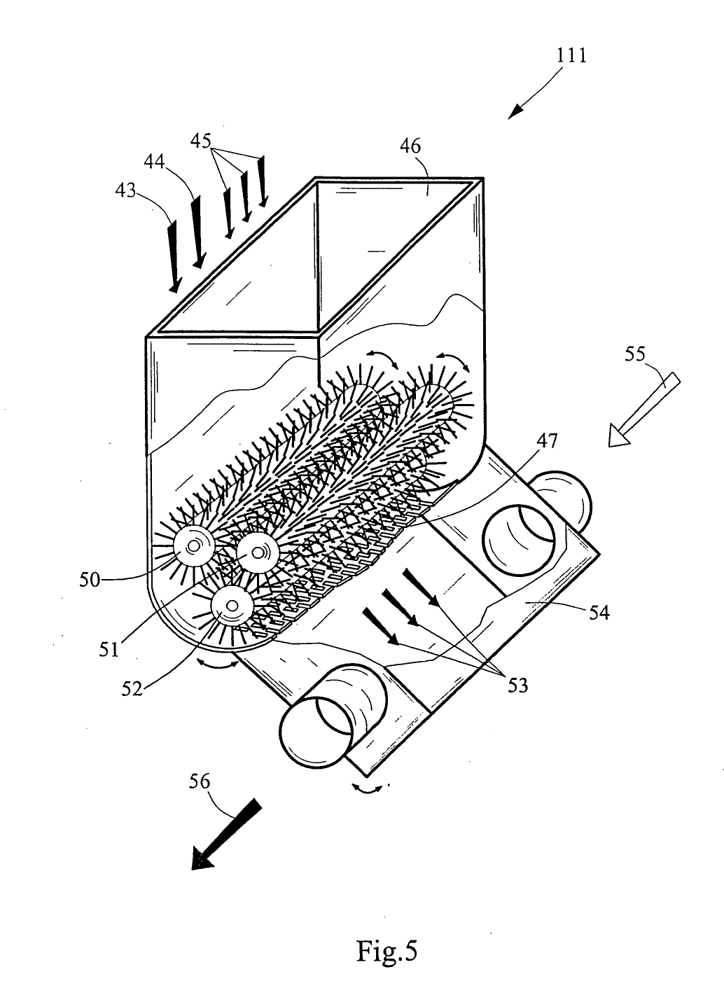

The method can furthermore be realized with differently configured and/or identically configured in parallel processing and metering lines, so that several different types of fiber materials can be processed and metered in parallel. The goal of the mixing operation is to achieve a homogeneous mixing of the individual fiber components and the different additives. A device as shown in FIG. 5 can be used for the mixing and/or metering. A primary metering step, for example, can be realized with a device as shown in FIG. 4.

During the mixing and/or metering step, the different fiber materials can be mixed continuously or discontinuously. A continuous mixing device 111, for example, is shown in FIG. 5, wherein the mixing device 111 also functions as intermediate storage for fiber materials. Not only is it possible to mix different fibers during this mixing and/or metering step, but additives can also be mixed in. These additives serve to bond together the fibers and/or to influence the filtration characteristics of the fiber filter.

The discharge from the mixing device 111 is defined, which results in a metering function. It may be possible to omit the primary metering 4 by using a mixing and/or metering 5. Following the metering 4 stage or the mixing and/or metering 5 stage, the fiber material is fed to a separating step 6. The goal for the separating is a total break-up of the remaining fiber groups into individual fibers, so that the fibers can be regrouped in a following continuous rod production step 7, such that an optimum nonwoven fiber structure without bridge-type connections and cavities can develop. It is important in this connection that an individual fiber can fit itself against other fibers to form a nonwoven structure. Thus, according to FIG. 1, it is possible to use up to three metering steps. Additional metering stages can also precede the initial separation process 1.

The fiber flow leaving the separating device(s) consists of individual fibers carried along by air and/or in an air flow. The appearance of the air flow carrying along fibers or a fiber-loaded air flow resembles a snow storm. For producing a continuous rod from the separated fibers, the fibers can be supplied, for example with a fluidized bed, to a suction belt of a special suction-belt conveyor. During the forming of the continuous rod 7, a continuous rod with constant cross section is created, wherein the cross section in particular has a constant square shape and a uniform density is created at the same time. The fibers are present in a nonwoven form at least up to the rod formation. The finished fiber filter rod has sufficient hardness, tensile resistance, weight consistency, retention and further processing ability.

FIG. 2 shows a fiber preparation arrangement 114. A fiber felt 10 is conveyed with feed rollers 11 to the operating range of a hammer crusher 13 with hammers 12. The hammers 12 of this hammer crusher 13 are located inside a housing 14. The hammers 12 hammer the fiber felt in the tear-off region 15, thus forming the fiber groups 16. The fiber groups 16 are transported further with an air flow 17 inside a pipe 18. An air flow 19 loaded with fiber groups is created. Individual fibers, not shown, can also be generated at this location. The hammers 12 of the hammer crusher 13 rotate in a downward direction so that the fibers are ejected in the direction of rotation of the crusher 13 and tangentially from housing 14.

A pre-metering device 113 is shown schematically in FIG. 3. An air flow loaded with fiber material 41 is supplied to a separator 20, which separates the fiber material 41 from the air flow so that the fiber material 42 drops through a chute 21 into a storage container 22. The lower part of the storage container 22 houses two spiked feed rollers 23. The spiked feed rollers 23 rotate slowly and deliver the fiber material to a third spiked feed roller 24. The third spiked feed roller 24 rotates quickly and tears fiber groups from the fiber material. These fiber groups travel to a funnel 25 by sliding downward. A rotary vane feeder 26 is arranged at the lower end of the funnel 25. The fiber groups slide into the cells of the rotary vane feeder 26 and are moved into the channel 27. An air flow 28 flows inside a channel 27 and carries along the fibers and/or fiber groups delivered to the channel 27. The air flow 28 also carries along individual fibers returned from the process, which are then supplied along with the fiber groups. The air flow 28 is loaded with fibers and fiber groups. A fiber/fiber group mixture 29 is transported with the aid of the air flow. The mass throughput can be adjusted by varying the speed of the rotating members, namely the spiked feed rollers 23 and 24 as well as that of the rotary vane feeder 26, so that a pre-metering can be realized.

FIG. 4 shows a schematic representation of a metering device 112 for realizing a primary metering operation. The fiber/fiber group mixture 29 is transported with an air flow to a separator 30, e.g. a rotary separator. There, the fiber/fiber group 31 is separated from the air flow, not shown. The separated out fiber material 31 travels to an accumulation chute 32 and drops downward through this chute to feed rollers 34. Several roller pairs or a pair of feed belts, not shown, and/or several feed belt pairs, not shown, can also be provided. Vibration elements 33 are provided for one section of the accumulation chute 32, which permit a continuous feeding of the fiber/fiber groups mixture 31 to the feed rollers 34.

The feed rollers 34 convey the fiber material 31 between the strippers 35 and into the metering channel 36 formed by the strippers. A rotating roller 37, e.g. a spiked feed roller, tears the fibers from the fiber material 31 and delivers these to a channel 38. An air flow 39 is present in the channel 38, which picks up the fibers and/or the fiber material 40 and correspondingly transports it in the direction of air flow 39. The fiber mass 31 flow, into the metering channel 36, is preset by the speed of the feed rollers 34.

FIG. 5 shows a three-dimensional, schematic representation of a mixing device 111. Different fiber materials 43 and 44 as well as additional fiber materials or additives 45 in liquid or solid phase are fed into a mixing chamber 46. The fiber materials can be cellulose fibers, fibers with a thermoplastic coating, flax fibers, hemp fibers, linseed fibers, sheep's wool fibers, cotton fibers or multi-component and in particular bi-component fibers, having a length shorter than the length of the filter to be produced and a thickness, for example, in the range of 25 to 30 μm. Cellulose fibers of the type “stora fluff EF untreated” by the company Stora Enso Pulp AB can be used, for example, which have an average cross section of 30 μm and a length of between 0.4 and 7.2 mm. For the synthetic fibers such as the bi-component fiber, it is possible to use fibers with a length of 6 mm of the type Trevira 255 3.0 dtex HM by the company Trevira GmbH. These fibers have a diameter of 25 μm. Cellulose acetate fibers, polypropylene fibers, polyethylene fibers and polyethylene terephthalat fibers can also be used for the synthetic fibers. Materials that influence the taste and/or smoke can furthermore be used as additives, such as activated carbon granulate or flavoring agents, as well as bonding agents that make the fibers stick together.

The fiber material 43 and 44 and/or the respective additives 45 that are fed into the mixing chamber 46 are supplied to rollers 50-52, which rotate with suitable speeds during the filling and the mixing operation. It is preferable if the position of rollers 50-52 can be adjusted in a horizontal as well as a vertical direction. As a result, the axial spacing, not shown, of the rollers can be adjusted relative to each other, wherein several rollers can furthermore be arranged on different levels. The components to be mixed are picked up by the rollers 50-52, are accelerated and churned up inside the mixing chamber 46. The churning causes the mixing of the components. The amount of time the mixing components spend inside the mixing chamber 46 can be adjusted with the geometric structure of a screen 47. In addition, the dwell time for the components to be mixed inside the mixing chamber 46 can be determined with a closing shutter (not shown) for closing the openings of the screen 47 partially or completely.

The fiber mixture and/or the fiber/additive mixture 53 is conveyed through openings of the screen 47 into a chamber 54, which can take place continuously or at intervals. An air flow 55 flows through the chamber 54, which preferably can pivot. The air flow 55 picks up the mixture 53 and pulls it along. The loaded air flow 56 leaves the chamber 54 and conveys the mixture 53 further.

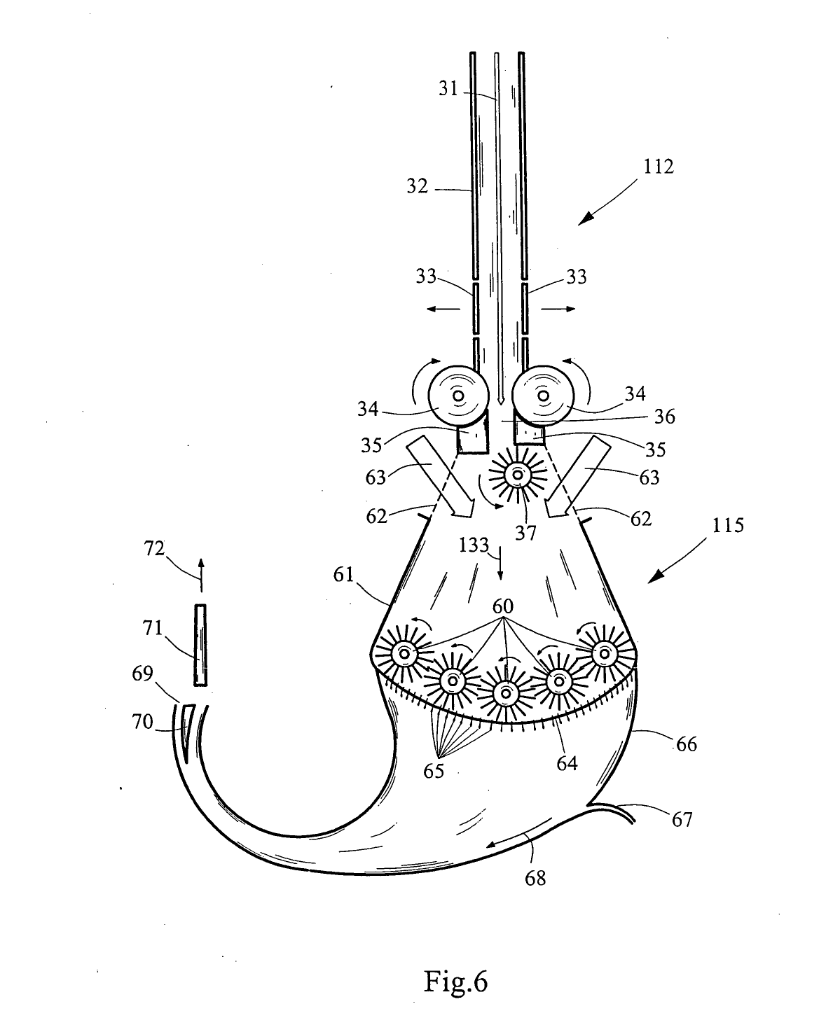

FIG. 6 shows a schematic representation of a separating device 115 in connection with a metering device 112. The metering device 112 essentially corresponds to the metering device shown in FIG. 4. However, the vibration elements 33 are shown as separate sections of the drop chute 32 and the strippers 35 differ slightly from those shown in FIG. 4. The fiber material, not shown, pulled from the metering channel 36 by the rotating roller 37 is fed directly to a separating chamber 61. The mass throughput in the metering channel 36 is determined by the speed of the feed rollers 34. Air flows through the complete separating device. This air flow 133 and 68 is generated by a reduced pressure caused on the one hand by an air flow 72 inside an exhaust pipe 71 and, on the other hand, by the flow in a suction belt conveyor that is arranged at a fluidized bed end 69 and is not shown in this Figure. The air flows 133 and 68 may also be augmented by an additional in-put of air.

Inside the separating chamber 61, the fibers and/or the fiber groups move under the effect of gravity and the influence of air flow 133 and/or the intake of air 63 through ventilation openings 62 to the region of rollers 60. The individual rollers 60 are aligned in the row and pick up the non-separated fibers (and of course also the partially separated fibers that are present), accelerate these fibers and beat these against a screen 64 of the separating chamber 61. Perforated sheets or round bar grids can also be used in place of a screen with exit surfaces.

As a result of mechanical stress, the fiber groups are separated into individual fibers and finally pass through the screen 64. Following a sufficient separation, the fibers are picked up by the flow 133 through the screen and are guided and/or suctioned through the screen 64. The speed of rollers 60 and the area of openings 64 as well as the intensity of the flow 133 determine the mass throughput of the separating chamber 61.

The separated fibers 65 travel to a fluidized bed 66 where they are picked up by an air flow 68 that can be augmented from an air nozzle, designed as a nozzle lip 67, and are moved along the fluidized bed 66. Several nozzle lips 67 can also be provided. The low pressure at the fluidized bed end 69 primarily ensures a sufficient flow 133 and 68 for transporting the separated fibers within chamber 61 and toward the fluidized bed end 69. At the fluidized bed end 69, the air flow 68 is, in part, separated from the fiber flow by a flow divider 70 and travels to the exhaust pipe 71. The flows 133 and 68, created by the low pressure and the nozzle lip 67, remove air from the separating chamber 61. Fresh air 63 flows through the ventilation openings 62 into the separating chamber 61.

The separated fibers, not shown, are transported in the fluidized bed region with the air flow 68, which includes air flow 133 previously used for the separation. This air flow moves in nearly a vertical direction until the fluidized bed is reached and subsequently moves along the fluidized bed. The flow 68 can be supplemented with additional air flows and/or air flow from one or more nozzles 67.

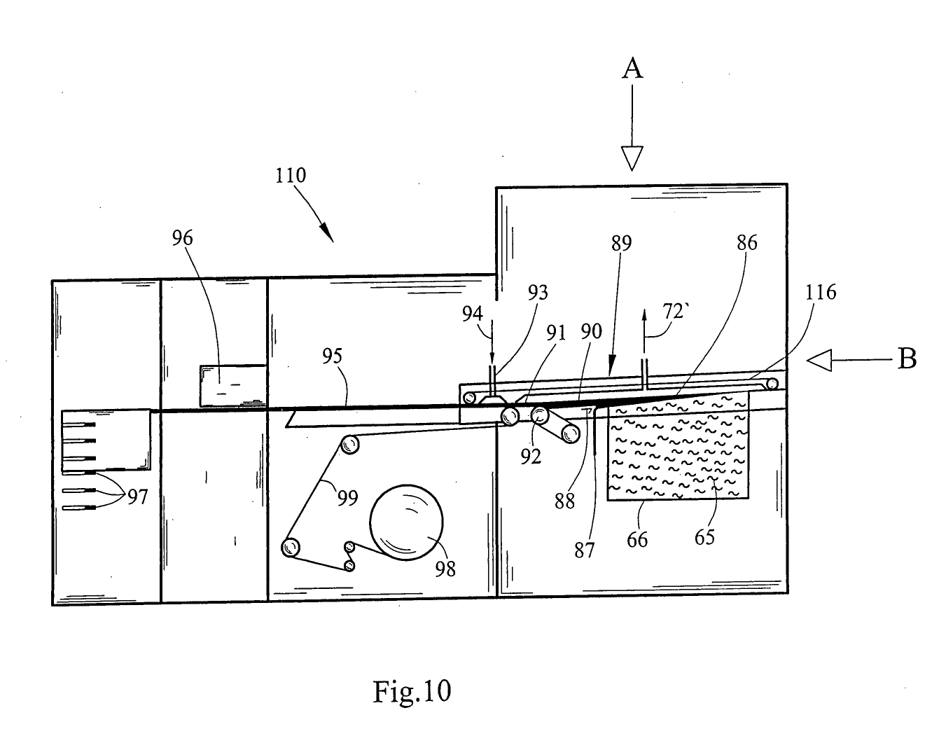

A suction belt conveyor follows the fluidized bed 66, but is not shown in this Figure (see also in particular FIGS. 10 and 12). The separated fibers are compiled on the suction belt, wherein two or more suction belts can also be used.

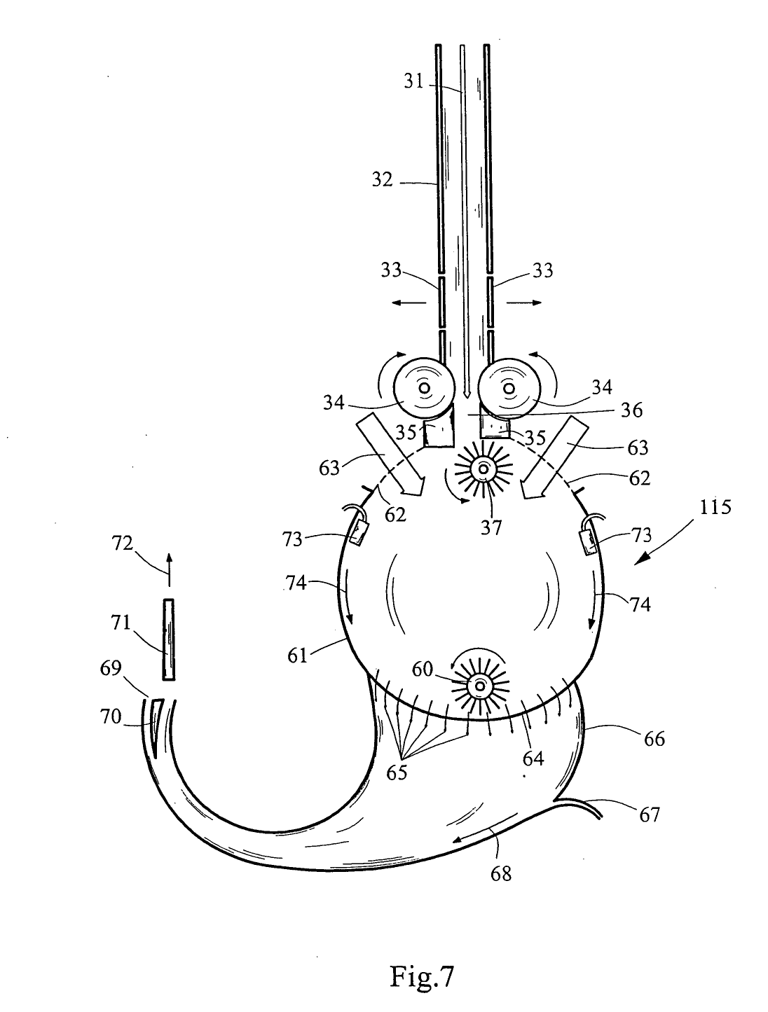

FIG. 7 shows a different embodiment of a separating device according to the invention. In contrast to the embodiment according to FIG. 6, only one roller 60 is provided for this exemplary embodiment. In addition, several air flows 74 are provided inside the separating chamber 61, which are generated with air nozzles 73. Several air nozzles 73 can also be used, as shown in FIG. 7. These not only can be arranged on the outside surface of the chamber, but can also be distributed in the separation chamber 61. The air flows guide the fibers to the roller 60, wherein several rollers can also be used in place of the one roller. The function of roller 60 and/or the several rollers 60 corresponds to the function described in FIG. 6. The air flows 74 cause an increased swirling inside the separation chamber 61, thus improving the separation of the fibers as compared to the embodiment shown in FIG. 6. The separated fibers 65 correspondingly travel through the screen 64 as shown in FIG. 6.

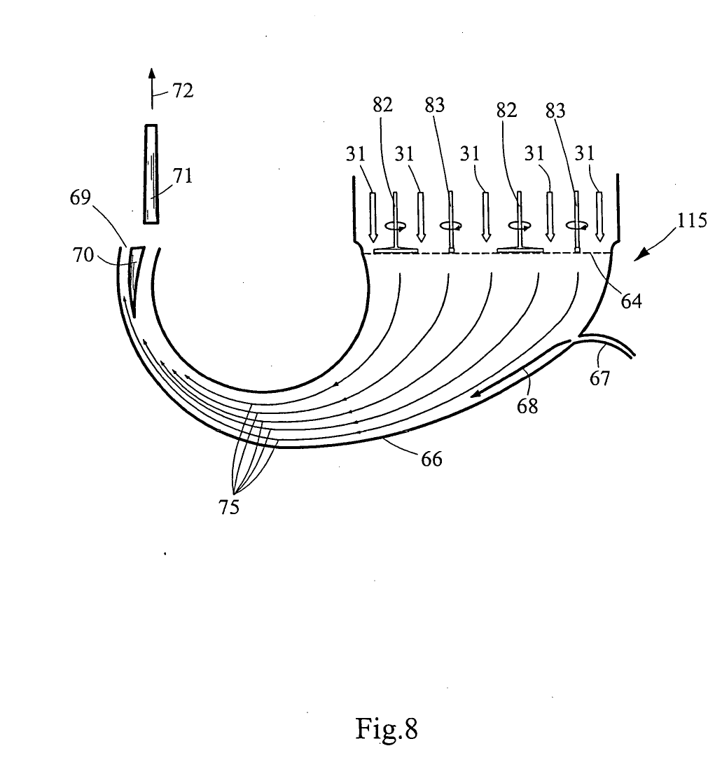

FIG. 8 shows a different embodiment of a separating device 115 according to the invention. The air flow in this case is generated by the low pressure at the end of the fluidized bed 69 and the air flow 68 flowing from the nozzle lip 67, wherein several nozzle lips can also be used. The main air flow starts above the screen 64 and passes by the rows of stirring mechanisms 82 and 83, as well as the screen 64. Following this, the main air flow travels to the fluidized bed region 66 and passes through the fluidized bed 66 to its end 69.

The essentially non-separated fiber material and/or the fiber/fiber group mixture 31 enters the partially shown housing above the screen 64. Instead of the position shown in FIG. 8, this housing can also be inclined at an angle, e.g. at 45° to the horizontal line. As a result of gravity as well as the main air flow, not shown, the fiber/fiber group mixture 31 travels to the region of stirring mechanisms 82 and 83. Stirring mechanisms 82 and 83 are arranged in rows (not shown) and that consist of successively arranged stirring rods that drive a suitable stirring mechanism. The stirring mechanisms are displaced at an angle of 90° relative to each other, wherein other displacement angles can be provided as well. The non-separated fiber groups are torn apart by the rotating stirring mechanisms, are then accelerated and tossed against the screen 64 of the housing. A perforated sheet or a round bar grid can also be used in place of the screen 64. The fiber groups and/or the fiber group mixtures 31 are tossed against the screen 64 until they have been separated into individual fibers and with the main air flow have passed through the screen 64. Subsequently, fibers 75 travel along the fluidized bed 66, as for the previous exemplary embodiments, and to a suction belt conveyor that is also not shown in FIG. 8. The separating device shown in FIG. 8 is known, at least with respect to the rows of stirring mechanisms 82 and 83, from European Patent Document EP 0 616 056 B1 owned by M+J Fibretech A/S, Denmark, the contents of which are incorporated fully into the present patent application.

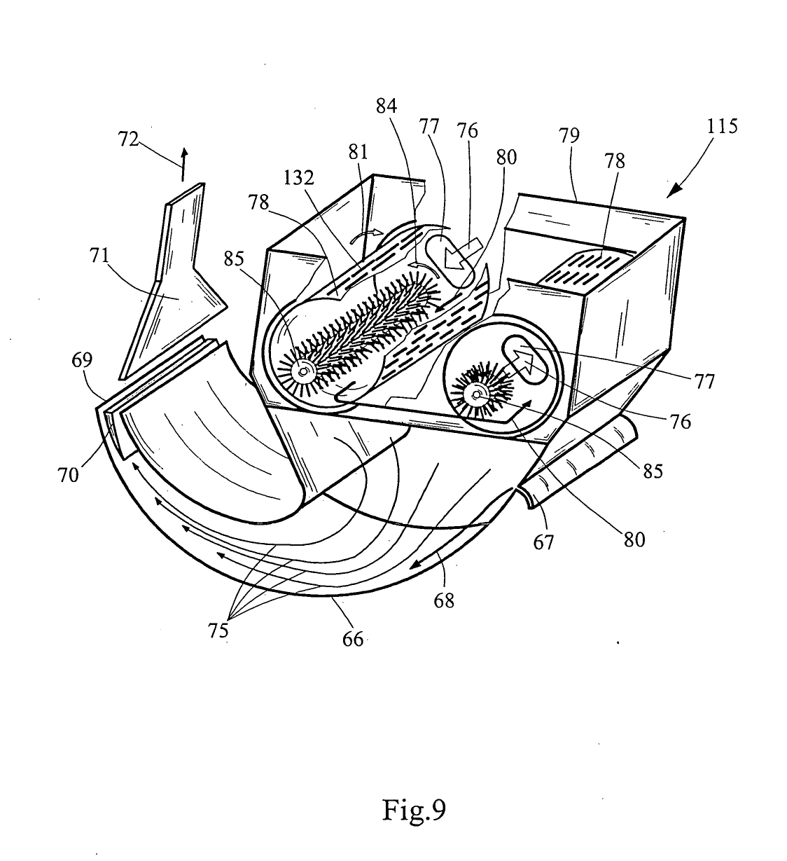

A different exemplary embodiment of the separating device 115 according to the invention is shown in a schematic, three-dimensional representation in FIG. 9. The essentially non-separated fiber material and/or fiber/fiber group mixture, not shown, is transported by air flows 76 to screening drums 78, via openings 77 on the side of housing 79. The fiber material is blown in the direction of the longitudinal axes into the screening drums 78. A circular flow 80 is generated by blowing the fiber material from both sides in counter-clockwise direction into the drum. This circular flow 80 is superimposed by a normal flow, not shown, and/or a flow that is essentially perpendicular thereto and is caused by a low pressure at the fluidized bed end 69 and an air flow 68. The low pressure at the fluidized bed end 69 is generated by a low pressure in a suction belt conveyor, not shown herein, which is arranged at the fluidized bed end 69, as well as by an air flow 72 flowing through the exhaust pipe 71. The normal flow starts above the screening drums 78 and passes through the screening drums 78 via the drum sleeve openings. The normal flow then travels to the fluidized bed region 66 and passes through this region to the end 69 where a portion of the normal flow is separated from the fibers at the wedge 70.

The non-separated fiber material inside the drums 78 is deposited on the inside sleeve surfaces of drums 78. The drums 78 rotate in a clockwise direction 81 as viewed in FIG. 9. The essentially non-separated fiber material deposited on the drum sleeve surfaces is then fed by the rotating drums to separating rollers 85. The separating rollers 85 rotate counter-clockwise in the direction 84 as viewed in FIG. 9. Alternatively, they could also rotate in the clockwise direction. The separating rollers 85 and/or the needle rollers pick up the non-separated fiber groups and tear these apart as well as accelerate them. The fiber groups are tossed against the inside drum sleeve surface of drums 78 until they have separated into individual fibers and have passed through the drum sleeve openings, meaning until they have been picked up by the air flow (the normal flow) and are guided and/or sucked through the screening drum 78. A drum with perforated sheets or round bar grids can also be used in place of the screening drum 78.

The fibers and/or separated fibers are picked up by an air flow and guided and/or sucked through the radial openings in the drum. The air flow 76 conveys the fibers in downward direction to the fluidized bed. As soon as the fiber-loaded flow arrives at the fluidized bed, it is deflected and guided along the curved fluidized bed. As a result of the gravitational forces acting upon the fibers, the fibers move toward the curved guide wall and flow to the suction belt conveyor. The air flowing along above the fibers is separated at the wedge and/or separator 70 and discharged via the exhaust pipe 71.

The respective fiber flows 75 are shown schematically in FIG. 9. Separated fibers are picked up by an air flow 68 that exits at the nozzle lip 67 and are also supplied to the fluidized bed end 69 with the air flow 68, in the same way as the separated fibers that are fed to the fluidized bed 66. Several nozzle lips can also be provided.

Fiber groups that are not separated or not completely separated during a single passage through the drums 78 are supplied via the circular flow 80 to the respectively parallel drum 78. For the separation, the fibers will flow through the openings 132 of the screening drums 78, wherein essentially only separated fibers can pass through the openings 132. The openings 132 are thus designed such that only separated fibers can pass through.

The separating device shown in FIG. 9 corresponds at least in part to the one disclosed in International Patent Publication WO 01/54873 A1 and U.S. Pat. No. 4,640,810 A. assigned to Scanweb of Denmark and/or the United States. The content disclosed in the above-referenced patent documents are incorporated fully into the disclosure of the present patent application.

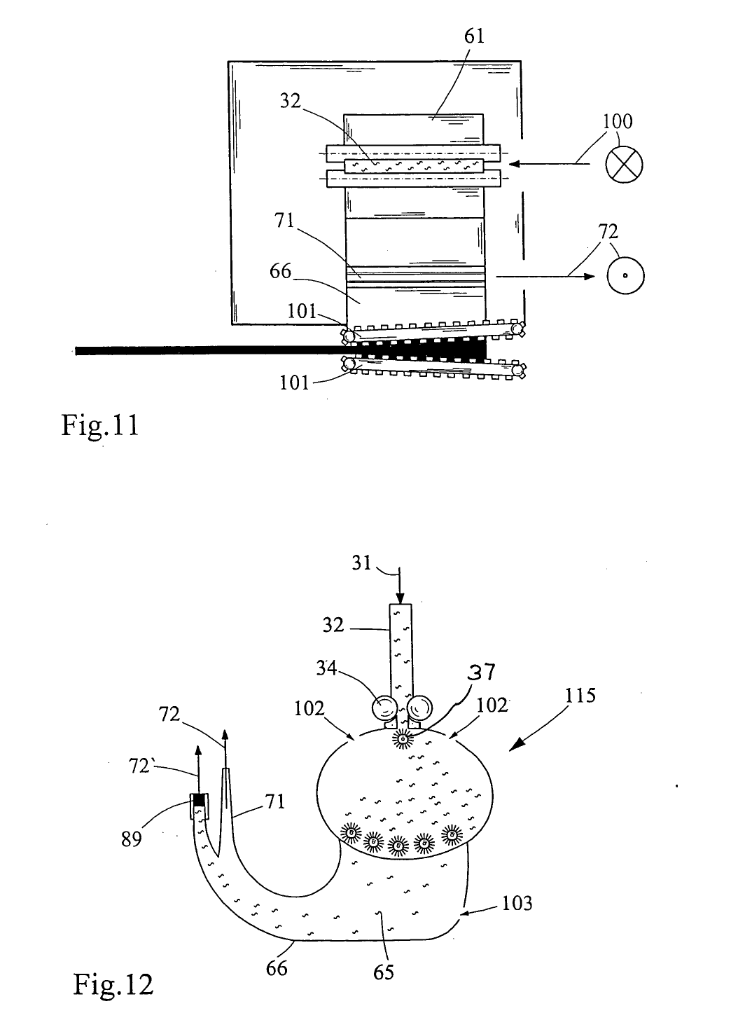

FIG. 10 shows a schematic representation of a continuous rod machine 110. FIG. 11 shows a portion of a continuous rod machine 110, in a view from above and along the arrow A. FIG. 12 shows a view from the side of the continuous rod machine 110 according to FIG. 10 in the direction of arrow B.

With reference to FIGS. 10-12, a non-separated fiber material travels via the accumulation chute 32 to the metering device 34, which in this example is represented by a pair of feed rollers 34 with a rotating roller 37. In FIG. 11, the direction of the material feed-in 100 is downward in the drawing plane, as shown schematically therein. The non-separated fiber material is separated in the separating chamber 61. The air flow at the fluidized bed 66, which is generated by the air flow in the exhaust pipe 71 and the air flow 72′ at the suction belt conveyor 89, conveys the separated fibers 65 (FIG. 12). According to FIG. 11, the direction of the air flow 72 in the exhaust pipe 71 is upward and out of the drawing plane. The air flow 72 also removes excess fibers. The air flow 72′ functions to hold in place the fibers 65 that are compiled on the suction belt 89 (FIGS. 10 and 12).

The separated fibers 65 move on the fluidized bed 66 in the direction toward the fluidized bed end where a suction belt conveyor 89 is arranged, as shown in the FIGS. 10-12. As a result of the continuous suctioning out of air, a low pressure is present at the suction belt conveyor 89. The suctioning out of air is shown schematically with the air flow 72′. The low pressure pulls the separated fibers 65 against the air-permeable suction belt of suction belt conveyor 89 and keeps them there.

The separated fibers 65 are correspondingly compiled on the air-permeable suction belt of the suction belt conveyor 89. The suction belt 116 moves in the direction of the continuous rod machine 110, meaning to the left in FIG. 10. A fiber cake and/or fiber flow 86, FIG. 10, forms on the suction belt, which increases nearly linearly in size in the direction toward the continuous rod machine 110. The compiled fiber flow 86 varies in thickness and is trimmed with a trimming device 88 to reach a uniform size. The trimming device 88 can be a mechanical device, e.g. trimming disks or plates, or a pneumatic device such as air nozzles. The mechanical trimming is known per se from continuous cigarette rod machines. For the pneumatic trimming, a nozzle that discharges an air flow is arranged horizontally at the end of the fiber flow 86 and tears out a portion of the fiber flow 86, so that excess fibers 87 are removed, wherein a pointed nozzle or a flat nozzle can be used as well.

Following the trimming operation, the fiber flow 86 is divided into a trimmed continuous fiber rod 90 and a rod of excess fibers 87. A nozzle jet, not shown, can also be used to pick up and tear off all fibers below a trimming dimension. The excess fibers are returned to the fiber preparation process and are later on used to form another continuous fiber rod.

The trimmed fiber rod 90 is held against the suction belt 116 and is moved in the direction of the continuous rod machine 110. The trimmed fiber rod 90 is a loose nonwoven fiber composite which is compacted with the aid of a compacting belt 92. However, a roller can also be used in place of the compacting belt 92, or several belts and/or rollers can be used. As shown in FIG. 11, the fiber cake is furthermore also compacted on the side, wherein FIG. 11 shows the compacting belts 101 moving toward each other at a conical angle while operated at the speed of the suction belt with the fiber cake. The serrated or toothed shape of the compacting belts 101 creates zones of varying density in the compacted fiber cake. The filter rod 91 is later on cut in the zones with higher density. The higher fiber density in the filter end region ensures a more compact consistency of the fibers in this sensitive zone and, additionally, makes it easier to process the filter rods. A compacting belt 92 is provided for the compacting in the vertical direction, wherein rollers can also be provided in place of the compacting belt 92.

The trimmed and compacted fiber rod 91 is transferred to the continuous rod machine 110. For the transfer, the compacted fiber rod 91 is lifted off the suction belt 116 and the rod 91 is then deposited on a format belt of the continuous rod machine 110, wherein the format belt is not shown in the Figures. The format belt can be a standard format belt, such as the ones used for a standard continuous filter rod machine and/or continuous cigarette rod machine. The transfer is aided by a nozzle 93, which directs an air flow 94 from the top onto the compacted fiber rod 91.

A continuous fiber filter rod 95 is formed in the continuous rod machine 110, wherein a bobbin 98 wraps a wrapping material web 99 in the standard way around the fiber material. A certain internal pressure builds up in the fiber filter rod 95 as a result of volume reduction and the shaping of the compacted fiber rod 91 into a circular and/or oval form during the wrapping with the wrapping material web 99. In a curing device 96, bonding components contained in the fiber mixture are heated on the surface and slightly melted. The outer layers of bi-component fibers can correspondingly be melted, so that a bond is created between the fibers. For this, we point in particular to German Patent Application DE 102 17 410.5, commonly owned by the assignee of the present application. The curing device 96 can also be a microwave heater, a laser heater, heating plates and/or sliding contacts. As a result of heating up the bonding components, the individual fibers in the fiber rod will bond and melt together on the surface. During the cooling of the fiber rod, the melted regions harden once more and the resulting grid structure imparts stability and hardness to the continuous fiber rod. Following this, the cured fiber filter rod 95 is cut into individual rod sections 97. The curing of the fiber filter can also take place following the cutting into fiber filter rod sections 97.

The air flow 102 shown in FIG. 12 also functions to transport the fiber materials, in the same way as the air flows in previous examples.

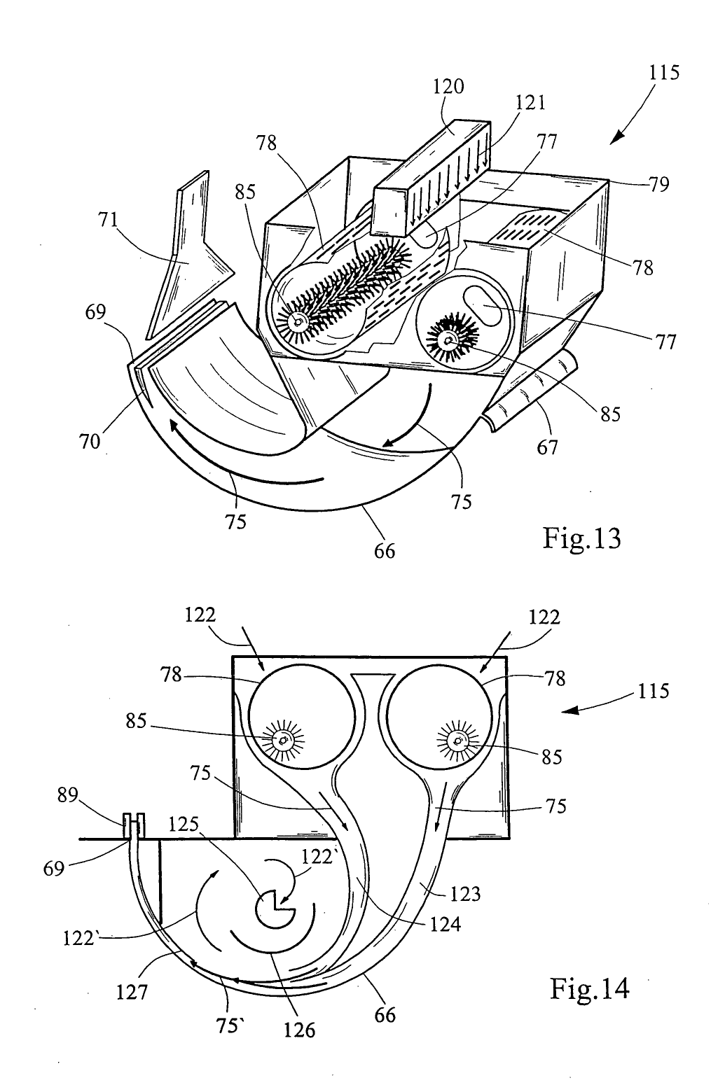

FIG. 13 shows a three-dimensional representation of a fifth embodiment of the separating device according to the invention, which is similar to the one shown in FIG. 9. A granulate metering device 120 is provided in addition to the embodiment shown in FIG. 9. The granulate metering device 120 pours granulate across the complete width of the separating device 115 into the separating device 115 between the screening drums 78. In the region of screening drums 78, the poured-in granulate 121 mixes with the fibers leaving the screening drums 78. A flowing mixture of separated fibers and granulate 75 is thus created, which is conveyed by the air flow on the fluidized bed to the suction belt conveyor, arranged in the conveying direction behind the suction belt end 69.

FIG. 14 shows a schematic cross sectional representation of a different separating device 115 according to the invention. The air flow is improved in this embodiment, so that more uniform air flows 75 and 75′ are created. An air flow 122 enters the arrangement in the upper region of the screening drum 78. The separated fibers leaving the screening drums 78 travel to the channels 123 and 124 and are moved downward with the respective air flow to the region of fluidized bed 66. The fiber flows 75 are combined to form a fiber flow 75′ in the lower region of the fluidized bed. In this region, a large portion of the transport air is separated from the fiber flow, which is shown with the air flow 122′. For this, an exhaust pipe 125 is provided in the rolling area 126 of the fluidized bed 66. Once the two fiber flows 75 are combined, the fiber flow 75′ flows into a channel formed by the fluidized bed 66 and the separator 127. At this location, a nonwoven fiber composite may already have formed, depending on the process sequence, or the fibers may still be separated. The fiber flow 75′ is subsequently transported with the aid of the low pressure at the suction belt conveyor 89 to the fluidized bed end 69 and the suction belt conveyor 89.

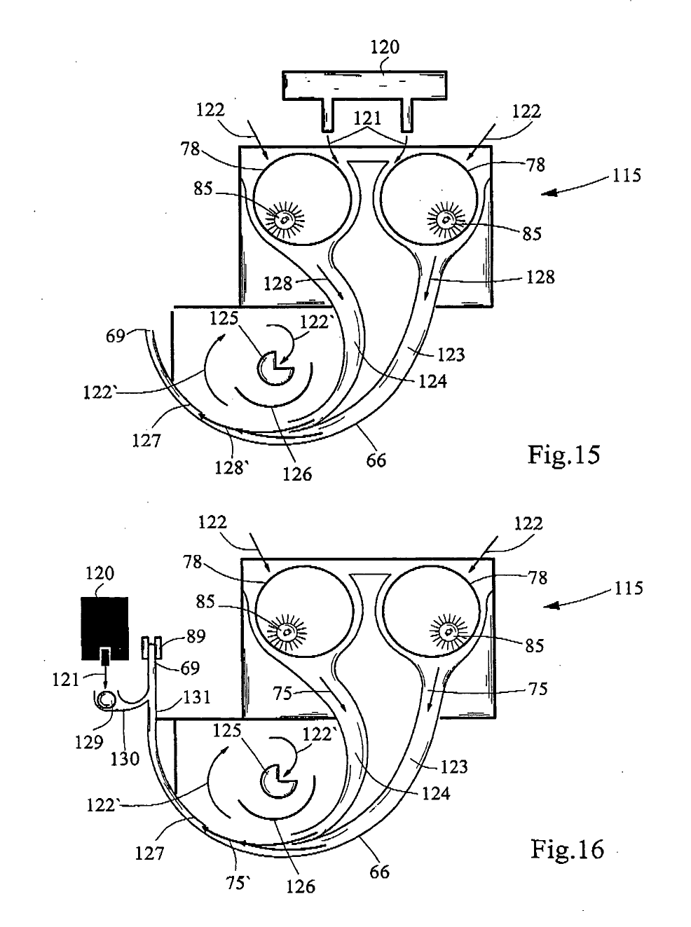

The schematic sectional representation in FIG. 15 is similar to the one shown in FIG. 14. However, a granulate metering device 120 is arranged above the screening drums 78 in a modification as compared to the embodiment shown in FIG. 14. Granulate 121 is supplied with two pipes to the respective screening drums 78. The resulting fiber/granulate flows 128, which are transported in the channels 123 and 124, are combined in the lower region of fluidized bed 66 to form a fiber/granulate flow 128′.

FIG. 16 represents a different embodiment according to the invention of a separating device 115. In this case, the granulate 121 from the granulate metering device 120 is supplied near the fluidized bed end 69. The granulate 121 reaches an acceleration element 129, which can be a roller, a brush or a nozzle. The accelerated granulate 121 travels through the line 130 to the fluidized bed, meaning to a vertical fluidized bed section 131.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A method for processing filter material for use in the manufacture of tobacco industry filters, the method comprising the steps of:
feeding a mass of finite fibers to a separating device;
separating the finite fibers into essentially individual separated fibers; and
transporting the separated fibers to a continuous rod machine.

2. The method according to claim 1, wherein the transporting step includes transporting the separated fibers at least in part with the aid of an air flow.

3. The method according to claim 1, wherein the separating step includes separating the fibers at least in part with the aid of an air flow.

4. The method according to claim 1, wherein the separating device comprises a device provided with a plurality of openings, and the separating step includes passing the fibers through the plurality of openings.

5. The method according to claim 1, wherein the feeding step includes supplying the fibers to the separating device at least in part by means of an air flow.

6. The method according to claims 1, wherein the separating step comprises more than one separating step.

7. The method according to claim 1, wherein the mass of finite fibers are a composite of fibers that have previously been separated into a less dense mass or masses.

8. The method according to claim 1, wherein at least one metering step is provided for the controlled metering of fibers or fiber masses to at least one method step.

9. The method according to claim 8, wherein the at least one metering step occurs during the separating step.

10. The method according to claim 1, wherein fibers of different compositions are used.

11. The method according to claim 10, wherein the different fibers are mixed.

12. The method according to claim 1, wherein at least one additive is combined with the fibers transported to the continuous rod machine.

13. The method according to claim 1, wherein at least two metering steps are completed prior to the transporting of the fibers to the continuous rod machine.

14. The method according to claim 1, wherein the average fiber diameter is in the range of 10 to 40 μm, in particular 20 to 38 μm.

15. A method for producing filters in the tobacco industry, the method comprising the method for processing filter material according to claim 1, and further comprising the steps of forming a continuous fiber rod and dividing the continuous fiber rod into filter rod sections.

16. The method according to 15, wherein the fiber length transported to the continuous rod machine is shorter than the length of divided filter rod section.

17. An arrangement for processing a mass of filter material comprised of finite fibers for use in the manufacture of filters in the tobacco industry, said arrangement comprising:
at least one separating device operative to separate the mass of fiber material into essentially individual finite fibers, wherein the separating device permits an essentially complete separation of the finite fibers;
at least one metering device to effect a controlled metering of fibers to the at least one separating device; and
at least one means for feeding the filter material from the at least one metering device to the at least one separating device.

18. The processing arrangement according to claim 17, wherein the means for feeding comprises an air flow.

19. The arrangement according to claim 17, wherein the at least one device for separating the fibers comprises an air flow.

20. The arrangement according to claim 17, wherein the separating device comprises a device provided with a plurality of openings for passing the fibers therethrough.

21. The processing arrangement according to claim 17, wherein the metering device comprises a drop chute from which a rotating roller removes the fibers.

22. The processing arrangement according to claim 21, wherein the metering device further comprises a pair of feed rollers in the lower region of the metering device.

23. The processing arrangement according to claim 17, wherein the separating device comprises at least one rotating element, and at least one element provided with a plurality of openings and an air flow.

24. The processing arrangement according claim 17, wherein the metering device comprises a fiber separating element.

25. The processing arrangement according to claim 17, further comprising a mixing device for mixing fibers and other filter additives of different compositions together.

26. The processing arrangement according to claim 25, wherein the mixing device comprises a fiber separating element.

27. The processing arrangement according to claim 25, wherein the mixing device comprises a fiber metering element.

28. The processing arrangement according to claim 17, wherein the finite fibers have an average fiber diameter in the range of 10 to 40 μm.

29. The processing arrangement according to claim 17, wherein the finite fibers have an average fiber diameter in the range of from about 20 to about 38 μm.

30. Filter rod sections produced according to the method of claim 15.
